(19) United States
(12) Patent Application Publication
(10) Pub. No.: US 2006/0270547 A1
(43) Pub. Date: Nov. 30, 2006

(54) N-heterocyclic carbenes that can be immobilized

(76) Inventors: Katrin Kohler, Gottingen (DE); Kerstin Weigl, Bad Salzungen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/567,748

(22) PCT Filed: Jul. 14, 2004
(86) PCT No.: PCT/EP04/07779

§ 371 Date: Feb. 10, 2006

(30) Foreign Application Priority Data
Aug. 11, 2003 (DE) 10337112.5

(51) Int. Cl. C07F 15/00; C07F 7/02; B01J 31/02

(52) U.S. Cl. 502/162; 548/110; 548/101

(57) ABSTRACT

The invention relates to immobilisable N-heterocyclic carbenes of the general formulae (I) and (II) 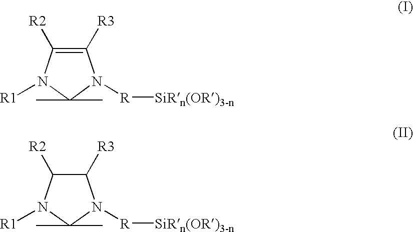
which contain an SiR′ₙ(OR′)₃₋ₙ-carrying group on one of the two nitrogen atoms of the heterocyclic ring. The invention furthermore relates to the use of the compounds as ligands for immobilisable and immobilised catalysts.

The invention relates to immobilisable N-heterocyclic carbenes of the general formulae (I) and (II) 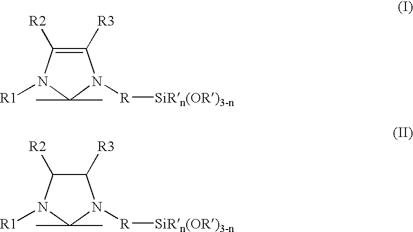
which contain an SiR′ₙ(OR′)₃₋ₙ-carrying group on one of the two nitrogen atoms of the heterocyclic ring. The invention furthermore relates to the use of the compounds as ligands for immobilisable and immobilised catalysts.

### 1. PRIOR ART AND OBJECT OF THE INVENTION

Examples of N-heterocyclic carbenes are described in WO 97/34875, WO 98/27064, WO 01/77081 and, for example, in J. Am. Chem. Soc. 1992, 114, 5530; Angew. Chem. 1997, 109, 2256; Tetrahedron 1999, 55, 14523; J. Organomet. Chem. 2000, 606(1), 49 and Angew. Chem. 2002, 114, 1343. In most cases, the substituents carry hydrocarbon radicals on both nitrogen atoms. N-heterocyclic carbenes containing donor-carrying groups on the nitrogen atoms, such as —OR, —NR₂ and —PR₂, are described, inter alia, in Chem. Eur. J. 1996, 12, 1627. The aim of this work was to make chelating N-heterocyclic carbenes accessible as complex ligands. The resultant coordination compounds containing N-heterocyclic carbene ligands have proven to be extremely effective homogeneous catalysts for a multiplicity of catalytic reactions. However, separation of the homogeneous catalysts from the reaction products is an expensive and complex operation. It would therefore be of major advantage to employ homogeneous catalysts immobilised on a support in the catalytic processes. Immobilised catalysts of this type can be separated off from the reaction products very simply by filtration.

The immobilisation of catalysts is of major interest in particular if the catalyst is very expensive. In this way, it could be recycled and employed again in the next catalytic process. It is also particularly advantageous for the reaction products of the catalytic process not to be contaminated with transition metals, as are present in the complex compounds. The latter applies in particular to products for pharmaceutical applications. The problems described here can be solved by the provision and use of immobilisable ligands which can be converted into immobilisable, catalytically active coordination compounds in subsequent reactions.

The object of the present invention was therefore to provide immobilisable and immobilised N-heterocyclic carbenes which can be employed both as such and in immobilised form as catalysts and can be prepared in a simple and inexpensive process. A further object of the invention was to provide corresponding immobilisable N-heterocyclic carbenes of high stability which can be covalently bonded to a suitable support, in particular to inorganic oxides as support materials, and are subsequently available in sufficiently large amount on the support surface for application reactions. To this end, it should be possible for them to be firmly anchored on the surface, and they should not be re-detached from the surface by addition of solvents.

### 2. DESCRIPTION OF THE INVENTION

The object is achieved by immobilisable N-heterocyclic carbenes of the general formulae (I) and (II): 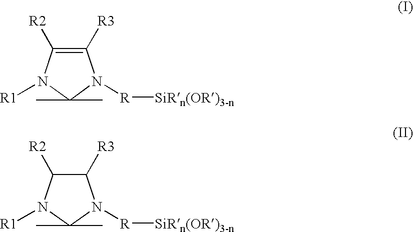
which contain an SiR′ₙ(OR′)₃₋ₙ-carrying group on one of the two nitrogen atoms of the heterocyclic ring and
in which
R is A, Ar, A-Ar, A-Ar-A, Het, AHet or AHetA having a total of not more than 30 carbon atoms, where
A is a straight-chain, branched, saturated or mono- or polyunsaturated C₁-C₂₀-alkyl radical, cycloalkyl or cycloalkyl bonded via one or two alkyl group(s) having a total of 4-30 carbon atoms, where one CH₂ or CH group both in the alkyl radical and in the cycloalkyl radical may be replaced by N, NH, NA, O and/or S,
Ar is mono- or polysubstituted or unsubstituted phenyl, naphthyl, anthryl or phenanthryl having a total of not more than 20 carbon atoms, where substituents may be A, Hal, OA, CO-AOH, COOH, COOA, COA, OH, CN, CONHA, NO₂, ═NH or ═O,
Het is a monocyclic or bicyclic, saturated, unsaturated or aromatic heterocyclic radical having from 1 to 4 N, O and/or S atoms, which may be unsubstituted or mono-, di- or trisubstituted by Hal and/or A, OA, CO-AOH, COOH, COOA, COA, OH, CN, CONHA, NO₂, ═NH or ═O,
R′, independently of the position in the molecule, is A, Ar, A-Ar or A-Ar-A having 1-12 carbon atoms,
R1 is A, Ar, AAr, AArA, Het, AHet or AHetA having 1-18 carbon atoms, in which the radical A which is not bonded to Ar or Het is alkyl or cycloalkyl which is unsubstituted or substituted by one or more groups Z, and Ar is an aromatic hydrocarbon which is unsubstituted or mono- or polysubstituted by a group Z, and Het is a saturated, unsaturated or aromatic heterocyclic radical, which may be mono- or polysubstituted by a group Z, and
R2 and R3, independently of one another, are H, Z, Hal or A, Ar or AAr having 1-18 carbon atoms, in which the radical A which is not bonded to Ar or Het is alkyl or cycloalkyl which is unsubstituted or substituted by one or more groups Z, and Ar is an aromatic hydrocarbon which is unsubstituted or mono- or polysubstituted by a group Z,
where
Hal is F, Cl, Br or I,
Z, independently of the position in R1, R2 and R3, is an N, P, O or S atom-containing functional group, A or Ar, and
n is 0, 1 or 2.

In particular, the object of the present invention is achieved by the provision of compounds as characterised by sub-claims 2 to 6, and very particularly by the compounds of the general formulae (I) and (II), which are 1-[3-(triethoxysilyl)ethyl]-3-[2,4-(di-i-propyl)phenyl]imidazol-2-ylidene 1-[3-(trimethoxysilyl)ethyl]-3-[2,4-(di-i-propyl)phenyl]imidazol-2-ylidene 1-[3-(triethoxysilyl)propyl]-3-[2,4-(di-i-propyl)phenyl]imidazol-2-ylidene 1-[3-(trimethoxysilyl)propyl]-3-[2,4-(di-i-propyl)phenyl]imidazol-2-ylidene 1-[3-(triethoxysilyl)butyl]-3-[2,4-(di-i-propyl)phenyl]imidazol-2-ylidene 1-[3-(trimethoxysilyl)butyl]-3-[2,4-(di-i-propyl)phenyl]imidazol-2-ylidene 1-[3-(triethoxysilyl)ethyl]-3-(mesityl)imidazol-2-ylidene 1-[3-(trimethoxysilyl)ethyl]-3-(mesityl)imidazol-2-ylidene 1-[3-(triethoxysilyl)propyl]-3-(mesityl)imidazol-2-ylidene 1-[3-(trimethoxysilyl)propyl]-3-(mesityl)imidazol-2-ylidene 1-[3-(triethoxysilyl)butyl]-3-(mesityl)imidazol-2-ylidene 1-[3-(trimethoxysilyl)butyl]-3-(mesityl)imidazol-2-ylidene 1-[3-(triethoxysilyl)ethyl]-3-(phenyl)imidazol-2-ylidene 1-[3-(trimethoxysilyl)ethyl]-3-(phenyl)imidazol-2-ylidene 1-[3-(triethoxysilyl)propyl]-3-(phenyl)imidazol-2-ylidene 1-[3-(trimethoxysilyl)propyl]-3-(phenyl)imidazol-2-ylidene 1-[3-(triethoxysilyl)butyl]-3-(phenyl)imidazol-2-ylidene 1-[3-(trimethoxysilyl)butyl]-3-(phenyl)imidazol-2-ylidene 1-[3-(triethoxysilyl)ethyl]-3-(cyclohexyl)imidazol-2-ylidene 1-[3-(trimethoxysilyl)ethyl]-3-(cyclohexyl)imidazol-2-ylidene 1-[3-(triethoxysilyl)propyl]-3-(cyclohexyl)imidazol-2-ylidene 1-[3-(trimethoxysilyl)propyl]-3-(cyclohexyl)imidazol-2-ylidene 1-[3-(triethoxysilyl)butyl]-3-(cyclohexyl)imidazol-2-ylidene 1-[3-(trimethoxysilyl)butyl]-3-(cyclohexyl)imidazol-2-ylidene 1-[3-(triethoxysilyl)ethyl]-3-(t-butyl)imidazol-2-ylidene 1-[3-(trimethoxysilyl)ethyl]-3-(t-butyl)imidazol-2-ylidene 1-[3-(triethoxysilyl)propyl]-3-(t-butyl)imidazol-2-ylidene 1-[3-(trimethoxysilyl)propyl]-3-(t-butyl)imidazol-2-ylidene 1-[3-(triethoxysilyl)butyl]-3-(t-butyl)imidazol-2-ylidene 1-[3-(trimethoxysilyl)butyl]-3-(t-butyl)imidazol-2-ylidene 1-[3-(triethoxysilyl)ethyl]-3-(i-propyl)imidazol-2-ylidene 1-[3-(trimethoxysilyl)ethyl]-3-(i-propyl)imidazol-2-ylidene 1-[3-(triethoxysilyl)propyl]-3-(i-propyl)imidazol-2-ylidene 1-[3-(trimethoxysilyl)propyl]-3-(i-propyl)imidazol-2-ylidene 1-[3-(triethoxysilyl)butyl]-3-(i-propyl)imidazol-2-ylidene 1-[3-(trimethoxysilyl)butyl]-3-(i-propyl)imidazol-2-ylidene 1-[3-(triethoxysilyl)ethyl]-3-(methyl)imidazol-2-ylidene 1-[3-(trimethoxysilyl)ethyl]-3-(methyl)imidazol-2-ylidene 1-[3-(triethoxysilyl)propyl]-3-(methyl)imidazol-2-ylidene 1-[3-(trimethoxysilyl)propyl]-3-(methyl)imidazol-2-ylidene 1-[3-(triethoxysilyl)butyl]-3-(methyl)imidazol-2-ylidene 1-[3-(trimethoxysilyl)butyl]-3-(methyl)imidazol-2-ylidene 1-[4-(trimethoxysilyl)benzyl]-3-(mesityl)imidazol-2-ylidene 1 [4-(triethoxysilyl)benzyl]-3-(mesityl)imidazol-2-ylidene 1-[4-(trimethoxysilyl)benzyl]-3-(cyclohexyl)imidazol-2-ylidene 1-[4-(triethoxysilyl)benzyl]-3-(cyclohexyl)imidazol-2-ylidene 1-[4-(trimethoxysilyl)benzyl]-3-(methyl)imidazol-2-ylidene 1-[4-(triethoxysilyl)benzyl]-3-(methyl)imidazol-2-ylidene 1-[4-(trimethoxysilyl)benzyl]-3-(phenyl)imidazol-2-ylidene 1-[4-(triethoxysilyl)benzyl]-3-(phenyl)imidazol-2-ylidene 1-[4-(trimethoxysilyl)benzyl]-3-(i-propyl)imidazol-2-ylidene 1-[4-(triethoxysilyl)benzyl]-3-(i-propyl)imidazol-2-ylidene 1-[4-(trimethoxysilyl)benzyl]-3-(t-butyl)imidazol-2-ylidene 1-[4-(triethoxysilyl)benzyl]-3-(t-butyl)imidazol-2-ylidene 1-[4-(trimethoxysilyl)benzyl]-3-[2,4-(di-i-propyl)phenyl]imidazol-2-ylidene 1-[4-(triethoxysilyl)benzyl]-3-[2,4-(di-i-propyl)phenyl]imidazol-2-ylidene 1-[4-(trimethoxysilyl)-2,4-(dimethyl)phenyl]-3-(mesityl)imidazol-2-ylidene 1-[4-(triethoxysilyl)-2,4-(dimethyl)phenyl]-3-(mesityl)imidazol-2-ylidene 1-[4-(trimethoxysilyl)-2,4-(dimethyl)phenyl]-3-(cyclohexyl)imidazol-2-ylidene 1-[4-(triethoxysilyl)-2,4-(dimethyl)phenyl]-3-(cyclohexyl)imidazol-2-ylidene.

The present invention also relates to a process for the preparation of compounds of the general formulae (I) and (II) in which a substituted imidazole of the general formula (III) 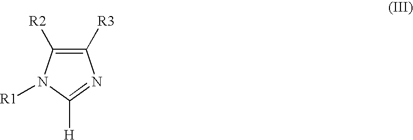
a substituted 4,5-dihydroimidazole of the general formula (IV) 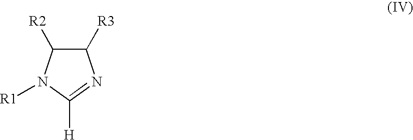
is reacted with a chlorine-, bromine- or iodine-containing alkoxysilane of the general formula
Hal-R—SiR′ₙ(OR′)₃₋ₙ
optionally in an inert, aprotic, organic solvent, to give alkoxysilyl-functionalised imidazolium salts of the general formula (V) 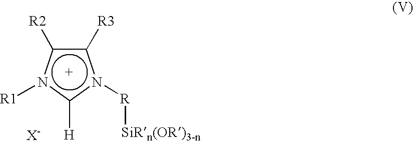
or alkoxysilyl-functionalised 4,5-dihydroimidazolium salts of the general formula (VI) respectively 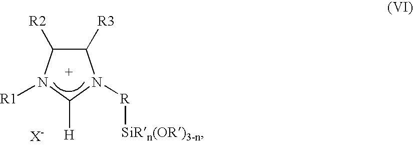
where, in the general formulae, R, R′, R1, R2 and R3 can adopt the above-mentioned meanings, and X⁻ can be an anion from the group consisting of F⁻, Cl⁻ Br⁻ and I⁻,
and
the resultant compounds of the general formula (V) or (VI) respectively, either directly in the resultant reaction mixture or after separation and, if necessary, purification, are reacted with a base selected from the group consisting of metal alkoxides (MOR), metal hydrides (MH), metal amides (MNH₂) and/or ammonia in an anhydrous, inert, aprotic, organic solvent which has, if appropriate, already been added in order to carry out the previous reaction, to give the carbenes of the general formula (I) or (II) respectively. The present invention furthermore relates to the particular embodiment of the process according to the invention as defined in claims 9 to 14.

The present invention furthermore relates to the use of the compounds of the general formulae (I) and (II) prepared as starting material for the preparation of immobilised N-heterocyclic carbenes of the general formulae (I) and (II), of immobilisable N-heterocyclic carbene complexes containing main-group metal atoms, rare-earth metal atoms and transition-metal atoms, and to the use of the compounds of the general formulae (I) and (II) as complex ligands for the preparation of catalysts and as starting material for the preparation of immobilisable catalysts or immobilised N-heterocyclic carbene catalyst ligands. The invention also relates to the use of compounds of the general formulae (I) and (II) as catalysts in organic or organometallic and transition metal-catalysed reactions and to the use as catalyst ligands in catalytic reactions, preferably as ligands of catalysts which are employed in C—C coupling reactions, oligomerisations, hydrogenations, hydroformylations, aminations, oxidations and reductions. In accordance with the invention, compounds of the general formulae (I) and (II) can serve as reaction media or as solvents in organic or organometallic and transition metal-catalysed reactions or as starting materials for immobilised reaction media, or as medium for the purification of reaction products (scavenger function).

The compounds of the general formulae (I) and (II) are prepared by reaction of trialkoxysilyl-functionalised imidazolium salts (V) and trialkoxysilyl-functionalised 4,5-dihydroimidazolium salts (VI) respectively in accordance with the general reaction equations Eq. 1 and Eq. 2 respectively with a base, such as, for example, a metal alkoxide of the general formula MOR or a base selected from the group consisting of metal hydrides MH, metal amides MNH₂ and ammonia in an anhydrous, inert, aprotic, organic solvent. After the by-products have been separated off, the compounds of the general formulae (I) and (II) can be obtained.

In the case of the use of a metal alkoxide MOR as base, the reaction takes place in accordance with the following reaction equations (Eq. 1 and Eq. 2):

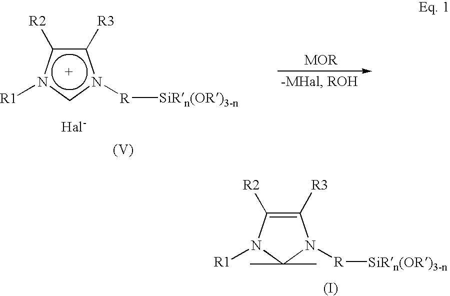

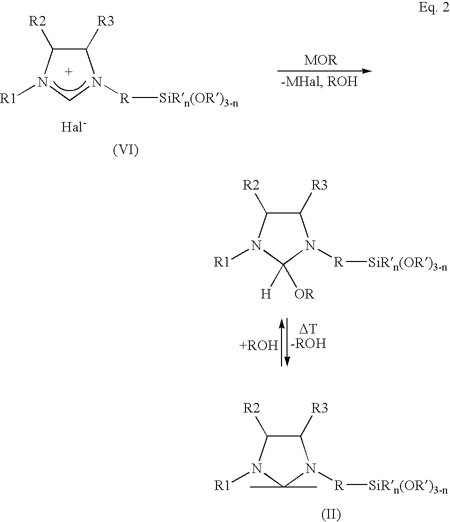

In the case of the use of a metal hydride MH as base, the reaction takes place in accordance with the following reaction equations (Eq. 3 and Eq. 4):

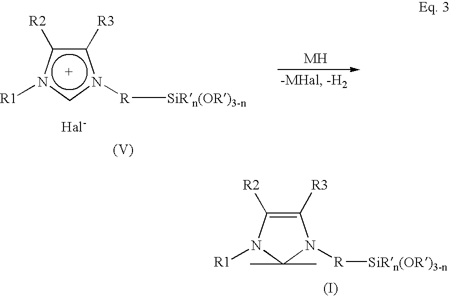

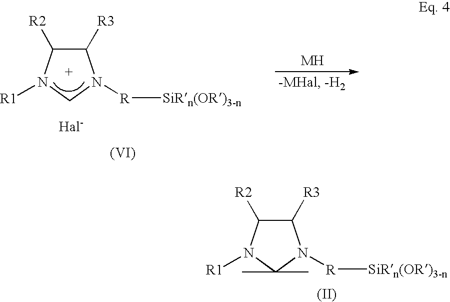

The compounds of the general formulae (I) and (II) can be used as complex ligands for the preparation of immobilisable N-heterocyclic carbene complexes and as ligands in catalytic reactions. They can furthermore be used as starting material for the preparation of immobilised N-heterocyclic carbenes and N-heterocyclic carbene complexes.

The advantages of the compounds of the general formulae (I) and (II) compared with the prior art are: the compounds are covalently immobilisable on a support. They and also all carbene complex compounds which can be prepared from them can thus be separated very simply from the reaction solutions or reaction products in application reactions. The compounds of the general formulae (I) and (II) and all carbene complex compounds which can be prepared from them can thus be recycled. This results in a saving of process costs in all application reactions, in particular in catalytic reactions using expensive transition-metal catalysts. The compounds of the general formulae (I) and (II) are accessible very simply and in quantitative yields.

### 3. DETAILED DESCRIPTION OF THE INVENTION

Compounds of the general formulae (I) and (II) according to the invention are 1,3-disubstituted imidazol-2-ylidenes and 1,3-disubstituted imidazolin-2-ylidenes. Compounds of the general formula (I) 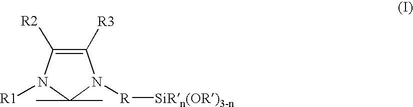
contain a 4,5-unsaturated dinitrogen heterocyclic ring, and compounds of the general formula (II) 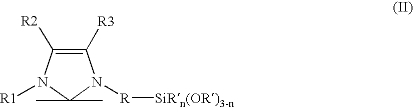
contain a saturated dinitrogen heterocyclic ring. In both types of compound, substituents are bonded to the two nitrogen atoms of the heterocyclic ring, where one of the two substituents carries a silyl group SiR′ₙ(OR′)ₙ₋₃. The carbon atom in the 2-position of the heterocyclic ring (between the two nitrogen atoms) is a divalent carbene carbon atom having a free electron pair.

An R—SiR′ₙ(OR′)ₙ₋₃ group is bonded to at least one of the two nitrogen atoms of the heterocyclic ring, where the Si(OR′)₃₋ₙ unit is capable of subsequent reaction with a metal oxide having active OH groups on the surface.

R′ in the SiR′ₙ(OR′)₃₋ₙ unit is a hydrocarbon radical, where n can be 0, 1 or 2, preferably 0 or 1 and very preferably 0. This hydrocarbon radical R′ can adopt different meanings independently of the position in the molecule and can be straight-chain, unbranched (linear), branched, saturated, mono- or polyunsaturated, cyclic (A), aromatic (Ar) or alkylaromatic (AAr or AArA), and optionally mono- or polysubstituted.

A and Ar can adopt all the meanings given below.

R′ is preferably a straight-chain, unbranched (linear), branched, saturated, mono- or polyunsaturated or cyclic saturated or mono- or polyunsaturated alkyl radical having 1-12 carbon atoms. R′ is particularly preferably a straight-chain or branched saturated alkyl radical having 1-7 carbon atoms, i.e. a sub-group of the alkyl group A, which is defined in greater detail below.

R′ can thus preferably adopt the meanings

methyl, ethyl, propyl, i-propyl, butyl, i-butyl, sec-butyl, tert-butyl, pentyl, 1-, 2- or 3-methylbutyl (—C₅H₁₀—), 1,1-, 1,2- or 2,2-dimethylpropyl (—C₅H₁₀—), 1-ethylpropyl (—C₅H₁₀—), hexyl (—C₆H₁₂—), 1-, 2-, 3- or 4-methylpentyl (—C₆H₁₂—), 1,1-, 1,2-, 1,3-, 2,2-, 2,3- or 3,3-dimethylbutyl (—C₆H₁₂—), 1- or 2-ethylbutyl (—C₆H₁₂—), 1-ethyl-1-methylpropyl (—C₆H₁₂—), 1-ethyl-2-methylpropyl (—C₆H₁₂—), 1,1,2- or 1,2,2-trimethylpropyl (—C₆H₁₂—), heptyl, octyl, nonyl, decyl, undecyl or dodecyl.

R′ is very particularly preferably a C₁-C₄-alkyl radical from the group consisting of methyl, ethyl, propyl, i-propyl, butyl, i-butyl, sec-butyl and tert-butyl.

In SiR′ₙ(OR′)ₙ₋₃, R′ can, however, alternatively be
alkenyl vinyl, propenyl, 1,2-propadienyl, butenyl, butadienyl, pentenyl, 1,2-, 1,4- or 1,3-pentadienyl, 2,3-dimethyl-2-butenyl, hexenyl, 1,5-hexadienyl, 2-methyl-1,3-butadienyl, 2,3-di-methyl-1,3-butadienyl or isopentenyl,
cycloalkenyl cyclopropenyl, cyclobutenyl, cyclopentenyl, cyclopentadienyl or methylcyclopentadienyl
and
alkynyl ethynyl, 1,2-propynyl, 2-butynyl, 1,3-butadiynyl, pentynyl or hexynyl.

The larger the number of alkoxy radicals in the SiR′ₙ(OR′)₃₋ₙ group and thus the smaller is n, the larger can be the number of covalent bonds between the metal oxide and the compounds of the general formulae (I) and (II) after immobilisation.

The SiR′ₙ(OR′)₃₋ₙ group is bonded to the nitrogen atom of the heterocyclic radical via a hydrocarbon radical R.

The hydrocarbon radical R is preferably a radical having 1-30 carbon atoms. This hydrocarbon radical may be straight-chain, unbranched (linear), branched, saturated, mono- or polyunsaturated, cyclic (A) or aromatic (Ar), heterocyclic or heteroaromatic (Het) and optionally mono- or polysubstituted.

The hydrocarbon radical R can be an A, Ar, A-Ar, A-Ar-A, Het, A-Het or A-Het radical, where each of the groups A, Ar and Het can adopt the meanings given below.
A is straight-chain, unbranched (linear), branched, saturated, mono- or polyunsaturated or cyclic alkyl radical A having 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms, preferably having 1, 2, 3, 4, 5, 6, 7, 8, 9, 10, 11 or 12 carbon atoms.

Alkylene has the same meanings as indicated for A, with the proviso that a further bond exists from the alkyl to the closest bonding neighbour.
A is, for example, an alkylene group selected from the group consisting of methylene (—CH₂—), ethylene (—C₂H₄—), propylene (—C₃H₆—), isopropylene (—C₃H₆—), butylene (—C₄H₈—), isobutylene (—C₄H₈—), sec-butylene (—C₄H₈—) and tert-butylene (—C₄H₈—), furthermore also pentylene (—C₅H₁₀—), 1-, 2- or 3-methylbutylene (—C₅H₁₀—), 1,1-, 1,2- or 2,2-di-methylpropylene (—C₅H₁₀—), 1-ethylpropylene (—C₅H₁₀—), hexylene (—C₆H₁₂—), 1-, 2-, 3- or 4-methylpentylene (—C₆H₁₂—), 1,1-, 1,2-, 1,3-, 2,2-, 2,3- or 3,3-dimethylbutylene (—C₆H₁₂—), 1- or 2-ethylbutylene (—C₆H₁₂—), 1-ethyl-1-methylpropylene (—C₆H₁₂—), 1-ethyl-2-methylpropylene (—C₆H₁₂—), 1,1,2- or 1,2,2-trimethylpropylene (—C₆H₁₂—), heptylene, octylene, nonylene, decylene, undecylene or dodecylene.

A can also be a cycloalkylene group having 3-30 carbon atoms, preferably C₃-C₉-cycloalkylene. Cycloalkyl here can be saturated or unsaturated and optionally bonded via one or two alkyl groups in the molecule to the imidazole nitrogen and the SiR′ₙ(OR′)ₙ₋₃ group. One or more H atom(s) may also be replaced by other substituents in the cycloalkylene group. Cycloalkyl is preferably cyclopropyl, cyclobutyl, cyclopentyl, cyclohexyl, methylcyclopentyl, cycloheptyl, methylcyclohexyl, cyclooctyl, 3-menthyl or camphor-10-yl (bicyclic terpene), decalin or bicycloheptane, where these groups can be bonded via one or two alkyl groups in the molecule to the imidazole nitrogen and the SiR′ₙ(OR′)ₙ₋₃ group.

In this case, cycloalkyl is preferably 1,2-cyclopropyl, 1,2- or 1,3-cyclobutyl, 1,2- or 1,3-cyclopentyl, or 1,2-, 1,3- or 1,4-cyclohexyl, furthermore 1,2-, 1,3- or 1,4-cycloheptyl. However, the said groups can also, as R3, be bonded in substituted or unsubstituted form to the second imidazole nitrogen.

A can also be an unsaturated alkenyl or alkynyl group having 2-20 carbon atoms, which can be bonded both to the imidazole nitrogen or an imidazole carbon and to the SiR′ₙ(OR′)ₙ₋₃ group.

Alkenyl groups can be straight-chain, branched or cyclic C₂-C₃₀-alkenyl groups, preferably straight-chain, branched or cyclic C₂-C₉-alkenyl groups, particularly preferably straight-chain or branched C₂-C₆-alkenyl groups from the group consisting of vinyl, propenyl, butenyl, pentenyl and hexenyl.

Cycloalkenyl groups can be straight-chain or branched C₃-C₃₀-cycloalkenyl groups, preferably C₃-C₉-cycloalkenyl groups, particularly preferably C₃-C₆-cycloalkenyl groups from the group consisting of cyclopropenyl, cyclobutenyl, cyclopentenyl, cyclohexenyl, cyclopentadienyl and methylcyclopentadienyl.

Alkynyl groups can be straight-chain or branched C₂-C₃₀-alkynyl groups, preferably straight-chain or branched C₂-C₉-alkynyl groups, particularly preferably straight-chain or branched C₂-C₆-alkynyl groups from the group consisting of ethynyl, propynyl, butynyl, pentynyl and hexynyl.

If alkenyl, cycloalkenyl or alkynyl is part of the hydrocarbon radical R, it of course has the same meanings, with the proviso that a further bond exists from the alkenyl or from the alkynyl to the closest bonding neighbour in the molecule.

Ar is a mono- or polycyclic aromatic hydrocarbon radical having 6-30 carbon atoms, which may be mono- or polysubstituted or unsubstituted.

Aryl groups can preferably be C₆-C₁₀-aryl groups, preferably phenyl or naphthyl. Alkylaryl groups can be C₇-C₁₈-alkylaryl groups, preferably tolyl or mesityl.
Ar is preferably substituted or unsubstituted phenyl, naphthyl, anthryl or phenanthryl, each of which may be mono-, di- or trisubstituted by A, OA, CO-AOH, COOH, COOA, fluorine, chlorine, bromine, iodine, hydroxyl, methoxy, ethoxy, propoxy, butoxy, pentyloxy, hexyloxy, nitro, cyano, formyl, acetyl, propionyl, trifluoromethyl, amino, methylamino, ethylamino, dimethylamino, diethylamino, benzyloxy, sulfonamido, methylthio, methylsulfinyl, methylsulfonyl, methylsulfonamido, ethylsulfonamido, propylsulfonamido, butylsulfonamido, dimethylsulfonamido, phenylsulfonamido, carboxyl, methoxycarbonyl, ethoxycarbonyl or aminocarbonyl, where Ar has not more than 20 carbon atoms if it is substituted by A and/or bonded to A.
Ar is preferably unsubstituted or mono- or polysubstituted phenyl, and specifically preferably phenyl, o-, m- or p-tolyl, o-, m- or p-ethyl-phenyl, o-, m- or p-propylphenyl, o-, m- or p-isopropylphenyl, o-, m- or p-tert-butylphenyl, o-, m- or p-cyanophenyl, o-, m- or p-methoxyphenyl, o-, m- or p-ethoxyphenyl, o-, m- or p-fluorophenyl, o-, m- or p-bromophenyl, o-, m- or p-chlorophenyl, o-, m- or p-methylthiophenyl, o-, m- or p-methylsulfinylphenyl, o-, m- or p-methylsulfonylphenyl, o-, m- or p-aminophenyl, o-, m- or p-methylaminophenyl, o-, m- or p-dimethylaminophenyl, o-, m- or p-nitrophenyl, 2,3-, 2,4-, 2,5-, 2,6-, 3,4- or 3,5-difluorophenyl, 2,3-, 2,4-, 2,5-, 2,6-, 3,4- or 3,5-dichlorophenyl, 2,3-, 2,4-, 2,5-, 2,6-, 3,4- or 3,5-dibromophenyl, 2-chloro-3-methyl-, 2-chloro-4-methyl-, 2-chloro-5-methyl-, 2-chloro-6-methyl-, 2-methyl-3-chloro-, 2-methyl-4-chloro-, 2-methyl-5-chloro-, 2-methyl-6-chloro-, 3-chloro-4-methyl-, 3-chloro-5-methyl- or 3-methyl-4-chlorophenyl, 2-bromo-3-methyl-, 2-bromo-4-methyl-, 2-bromo-5-methyl-, 2-bromo-6-methyl-, 2-methyl-3-bromo-, 2-methyl-4-bromo-, 2-methyl-5-bromo-, 2-methyl-6-bromo-, 3-bromo-4-methyl-, 3-bromo-5-methyl- or 3-methyl-4-bromophenyl, 2,4- or 2,5-dinitrophenyl, 2,5- or 3,4-dimethoxyphenyl, 2,3,4-, 2,3,5-, 2,3,6-, 2,4,6- or 3,4,5-trichloro-phenyl, 2,4,6-tri-tert-butylphenyl, 2,5-dimethylphenyl, 4-iodophenyl, 4-fluoro-3-chlorophenyl, 4-fluoro-3,5-dimethylphenyl, 2-fluoro-4-bromophenyl, 2,5-difluoro-4-bromophenyl, 2,4-dichloro-5-methylphenyl, 3-bromo-6-methoxyphenyl, 3-chloro-6-methoxyphenyl, 2-methoxy-5-methylphenyl, 2,4,6-triisopropylphenyl, 1,3-benzodioxol-5-yl, 1,4-benzodioxan-6-yl, benzothiadiazol-5-yl or benzoxadiazol-5-yl or naphthyl.

Arylene has the same meanings as indicated for Ar, with the proviso that a further bond exists from the aromatic system to the closest bonding neighbour.

Specifically, the group referred to as Het can adopt the following meanings:
Het is a mono- or bicyclic saturated, unsaturated or aromatic heterocyclic radical having from 1 to 4 N, O and/or S atoms, which may be unsubstituted or mono-, di- or trisubstituted by Hal and/or A, OA, CO-AOH, COOH, COOA, COA, OH, CN, CONHA, NO₂, ═NH or ═O, where Hal is F, Cl, Br or I.
Het is preferably chromen-2-onyl, pyrrolyl, imidazolyl, pyridyl, pyrimidyl, piperidinyl, 1-methylpiperidinyl, indolyl, thiophenyl, furyl, imidazolyl, pyrazolyl, oxazolyl, isoxazolyl, thiazolyl, isothiazolyl, triazolyl, thienyl, tetrazolyl, oxadiazolyl, thiadiazolyl, thiopyranyl, pyridazinyl, pyrazyl, benzofuryl, benzothienyl, indolyl, 2,1,3-benzothiadiazolyl, benzimidazolyl, benzopyrazolyl, benzoxazolyl, benzisoxazolyl, benzothiazolyl, benzisothiazolyl, benz-2,1,3-oxadiazolyl, quinolyl, isoquinolyl or cinnolinyl, each of which is unsubstituted or mono- or disubstituted by Hal and/or A,
where substituents can be A, OA, CO-AOH, COOH, COOA, fluorine, chlorine, bromine or iodine.
Het is particularly preferably 2- or 3-furyl, 2- or 3-thienyl, 1-, 2- or 3-pyrrolyl, 1-, 2-, 4- or 5-imidazolyl, 1-, 3-, 4- or 5-pyrazolyl, 2-, 4- or 5-oxazolyl, 3-, 4- or 5-isoxazolyl, 2-, 4- or 5-thiazolyl, 3-, 4- or 5-isothiazolyl, 2-, 3- or 4-pyridyl, 1-methylpiperidin-4-yl or piperidin-4-yl, or 2-, 4-, 5- or 6-pyrimidinyl, furthermore preferably 1,2,3-triazol-1-, -4- or -5-yl, 1,2,4-triazol-1-, -3- or -5-yl, 1- or 5-tetrazolyl, 1,2,3-oxadiazol-4- or -5-yl, 1,2,4-oxadiazol-3- or -5-yl, 1,3,4-thiadiazol-2- or -5-yl, 1,2,4-thiadiazol-3- or -5-yl, 1,2,3-thiadiazol-4- or -5-yl, 2-, 3-, 4-, 5- or 6-2H-thiopyranyl, 2-, 3- or 4-4-H-thiopyranyl, 3- or 4-pyridazinyl, pyrazinyl, 2-, 3-, 4-, 5-, 6- or 7-benzofuryl, 2-, 3-, 4-, 5-, 6- or 7-benzothienyl, 1-, 2-, 3-, 4-, 5-, 6- or 7-indolyl, 1-, 2-, 4- or 5-benzimidazolyl, 1-, 3-, 4-, 5-, 6- or 7-benzopyrazolyl, 2-, 4-, 5-, 6- or 7-benzoxazolyl, 3-, 4-, 5-, 6- or 7-benzisoxazolyl, 2-, 4-, 5-, 6- or 7-benzothiazolyl, 2-, 4-, 5-, 6- or 7-benzisothiazolyl, 4-, 5-, 6- or 7-benz-2,1,3-oxadiazolyl, 2-, 3-, 4-, 5-, 6-, 7- or 8-quinolyl, 1-, 3-, 4-, 5-, 6-, 7- or 8-isoquinolyl, 3-, 4-, 5-, 6-, 7- or 8-cinnolinyl, 2-, 4-, 5-, 6-, 7- or 8-quinazolinyl, 4- or 5-isoindolyl, 5- or 6-quinoxalinyl, 2-, 3-, 5-, 6-, 7- or 8-2H-benzo[1,4]oxazinyl, furthermore preferably 1,3-benzodioxol-5-yl, 1,4-benzodioxan-6-yl, 2,1,3-benzothiadiazol-4- or -5-yl, 2,1,3-benzoxadiazol-5-yl or chromenyl.

The heterocyclic radicals may also be partially or completely hydrogenated and adopt the following meanings:
Het is 2,3-dihydro-2-, -3-, -4- or -5-furyl, 2,5-dihydro-2-, -3-, -4- or -5-furyl, tetrahydro-2- or -3-furyl, 1,3-dioxolan-4-yl, tetrahydro-2- or -3-thienyl, 2,3-dihydro-1-, -2-, -3-, -4- or -5-pyrrolyl, 2,5-dihydro-1-, -2-, -3-, -4- or -5-pyrrolyl, 1-, 2- or 3-pyrrolidinyl, tetrahydro-1-, -2- or -4-imidazolyl, 2,3-dihydro-1-, -2-, -3-, -4- or -5-pyrazolyl, tetrahydro-1-, -3- or -4-pyrazolyl, 1,4-dihydro-1-, -2-, -3- or -4-pyridyl, 1,2,3,4-tetrahydro-1-, -2-, -3-, -4-, -5- or -6-pyridyl, 1-, 2-, 3- or 4-piperidinyl, 2-, 3- or 4-morpholinyl, tetrahydro-2-, -3- or -4-pyranyl, 1,4-dioxanyl, 1,3-dioxan-2-, -4- or -5-yl, hexahydro-1-, -3- or -4-pyridazinyl, hexahydro-1-, -2-, -4- or -5-pyrimidinyl, 1-, 2- or 3-piperazinyl, 1,2,3,4-tetrahydro-1-, -2-, -3-, -4-, -5-, -6-, -7- or -8-quinolyl, 1,2,3,4-tetrahydro-1-, -2-, -3-, -4-, -5-, -6-, -7- or -8-isoquinolyl, or 2-, 3-, 5-, 6-, 7- or 8-3,4-dihydro-2H-benzo[1,4]oxazinyl, furthermore preferably 2,3-methylenedioxyphenyl, 3,4-methylenedioxyphenyl, 2,3-ethylenedioxyphenyl, 3,4-ethylenedioxyphenyl, 3,4-(difluoromethylenedioxy)phenyl, 2,3-dihydrobenzofuran-5- or -6-yl, 2,3-(2-oxomethylenedioxy)phenyl or alternatively 3,4-dihydro-2H-1,5-benzodioxepin-6- or -7-yl, furthermore preferably 2,3-dihydrobenzofuranyl or 2,3-dihydro-2-oxofuranyl.

Heterocycloalkylene or heterocycloarylene has the same meanings as indicated for Het, with the proviso that a further bond exists from the heterocyclic system to the closest bonding neighbour.

Heterocycloalkylene is preferably 1,2-, 2,3- or 1,3-pyrrolidinyl, 1,2-, 2,4-, 4,5- or 1,5-imidazolidinyl, 1,2-, 2,3- or 1,3-pyrazolidinyl, 2,3-, 3,4-, 4,5- or 2,5-oxazolidinyl, 1,2-, 2,3-, 3,4- or 1,4-isoxazolidinyl, 2,3-, 3,4-, 4,5- or 2,5-thiazolidinyl, 2,3-, 3,4-, 4,5- or 2,5-isothiazolidinyl, 1,2-, 2,3-, 3,4- or 1,4-piperidinyl, or 1,4- or 1,2-piperazinyl, furthermore preferably 1,2,3-tetrahydrotriazol-1,2- or -1,4-yl, 1,2,4-tetrahydrotriazol-1,2- or -3,5-yl, 1,2- or 2,5-tetrahydrotetrazolyl, 1,2,3-tetrahydrooxadiazol-2,3-, -3,4-, -4,5- or -1,5-yl, 1,2,4-tetrahydrooxadiazol-2,3-, -3,4- or -4,5-yl, 1,3,4-tetrahydrothiadiazol-2,3-, -3,4-, -4,5- or -1,5-yl, 1,2,4-tetrahydrothiadiazol-2,3-, -3,4-, -4,5- or -1,5-yl, 1,2,3-thiadiazol-2,3-, -3,4-, -4,5- or -1,5-yl, 2,3- or 3,4-morpholinyl, or 2,3-, 3,4- or 2,4-thiomorpholinyl.

The hydrocarbon radical R is very particularly preferably a group having not more than 20 carbon atoms and adopts meanings selected from compounds which count amongst the C₁-C₁₂-alkylene groups, C₃-C₁₀-cycloalkylene groups, or C₄-C₂₀-cycloalkylene groups, C₆-C₁₄-arylene groups or C₇-C₂₀-alkylarylene groups, bonded via one or two alkyl group(s), and of these particularly preferably a C₁-C₄-alkylene chain from the series consisting of methylene, ethylene, propylene and butylene or a C₆-C₈-arylene chain from the series consisting of —C₆H₄— and —C₆H₂Me₂- or a C₇-C₉-alkylaryl chain from the series consisting of —CH₂C₆H₄—, —CH₂C₆H₂Me₂-, —CH₂C₆H₄CH₂— and —CH₂C₆H₂Me₂CH₂—.

R1 is a hydrocarbon radical which can adopt all meanings of A, Ar, AAr, AArA, Het, AHet or AHetA, in which H atoms may be replaced by functional groups Z. This hydrocarbon radical may be straight-chain, unbranched (linear), branched, saturated, mono- or polyunsaturated, cyclic (A) or aromatic (Ar), heterocyclic or heteroaromatic (Het) and optionally mono- or polysubstituted. The hydrocarbon radical R1 is in particular a radical which exerts a stabilising action on the carbene function of the compounds of the general formulae (I) and (II). The H atoms in R3 may be replaced by functional groups Z as defined below.

R1 is preferably an aliphatic, aromatic or heteroaromatic hydrocarbon radical, more precisely, as described above, an aliphatic radical A, an aromatic hydrocarbon Ar from the groups listed above or a heterocyclic substituent Het as defined above. R1 is very preferably an aliphatic, a cyclic aliphatic or an aromatic hydrocarbon radical having 1-18 carbon atoms. From this group of compounds, the radicals phenyl, tolyl, 2,6-dimethylphenyl, mesityl, 2,6-diisopropylphenyl, 2,4,6-triisopropylphenyl or cyclohexyl have proven particularly suitable and have resulted in particularly advantageous properties of the compounds prepared.

R2 and R3, independently of one another, can be H or can adopt all meanings of Hal, A, Ar and AAr as indicated above, where H atoms in A and Ar may be replaced by functional groups Z, and Hal can be F, Cl, Br or I. R2 and R3 particularly preferably adopt the meanings of R1 or are H, Cl or Br. R2 and R3 are particularly preferably, independently of one another, H, Cl, Br, a straight-chain, branched, saturated or mono- or polyunsaturated C₁-C₇-alkyl radical, where one or more H in the alkyl radical may be replaced by Z.

As already described, H atoms in all hydrocarbon radicals R, R1, R2 and R3, but in particular in R1, may be replaced by functional groups Z and carry N, P, O or S atoms. They can be groups which have one or more alcohol, aldehyde, carboxyl, amine, amide, imide, phosphine, ether or thioether functions, i.e. they can be, inter alia, radicals having the meanings OA, NHA, NAA′, PAA′, CN, NO₂, SA, SOA, SO₂A or SO₂Ar, where A, A′ and A″, independently of one another, can adopt the meanings of A in accordance with the definition given. They can be groups which have one or more alcohol (OA), aldehyde, carboxyl, amine, amide, imide, phosphine, ether or thioether functions. A group Z preferably has the meaning OA, NHA, NAA′ or PAA′.

R2 and R3 can therefore, for example, also be SO₃H, F, Cl, or a hydroxyl, alkanoyl or cycloalkanoyl radical.

R1, R2 and R3 can be methoxy, ethoxy, propionyl, butyryl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl or octadecanoyl.

R1, R2 and R3 can also be acyl radicals. R1, R2 and R3 can preferably be acyl radicals having 1, 2, 3, 4, 5, 6, 7, 8, 9 or 10 carbon atoms and can be, for example, formyl, acetyl, propionyl, butyryl, trifluoroacetyl, benzoyl or naphthoyl. R1, R2 and R3 can furthermore be amino, methylamino, dimethylamino, methylthio, methylsulfinyl, methylsulfonyl or phenylsulfonyl groups.

In addition, one, two or three methylene groups in the radicals R1, R2 and R3 in alkyl, alkylene, cycloalkyl, cycloalkylene, alkanoyl and cycloalkanoyl may each be replaced by N, O and/or S.

A hydrocarbon group in R1, R2 and R3 can thus adopt the meanings of A, Ar or AAr and can be an alkyl, alkenyl, aryl, alkylaryl or alkynyl group as defined above, in which one or more H atoms may be replaced by the above-mentioned functional groups Z.

The parent structures of the substituted imidazoles required as starting materials for the preparation of the compounds of the general formula (I) can be prepared analogously to the synthetic method described in the patent specification U.S. Pat. No. 6,177,575 in accordance with the following general reaction equation:

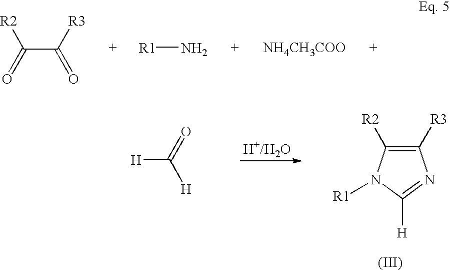

The parent structure (IV) of the compounds of the general formula (II) (substituted 4,5-dihydroimidazole) can be synthesised by methods which are described in Tetrahedron Lett. 1980, 21, 885, Chem. Ber. 1965, 98, 1342 and in DE-A-11 89 998.

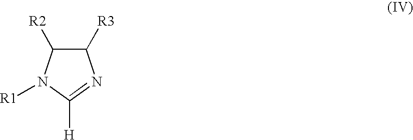

The preparation of the compounds of the general formulae (V) and (VI) substituted by silyl groups on the second nitrogen atom of the imidazole ring can be carried out by reaction of a substituted imidazole of the general formula (III) or substituted 4,5-dihydroimidazole of the general formula (IV) with chlorine-, bromine- or iodine-containing alkoxysilanes
Hal-R—SiR′ₙ(OR′)₃₋ₙ without addition of a further solvent (Eq. 6, Eq. 7). However, it is also possible to carry out the reaction in an inert, aprotic, organic solvent.

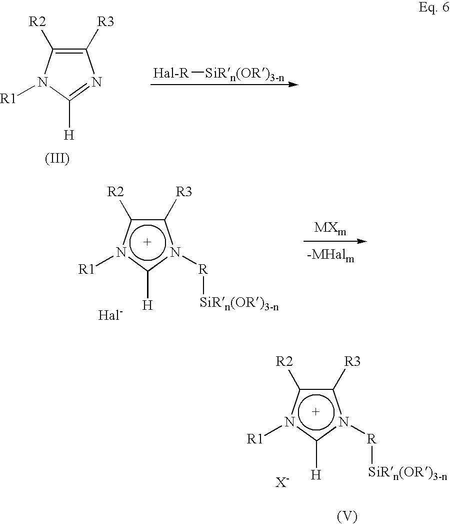

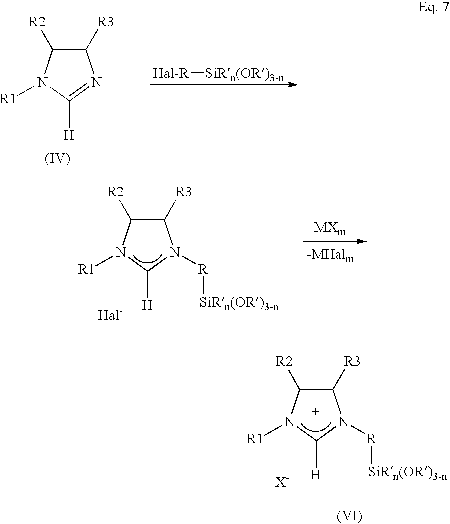

The products formed can be isolated in pure form as stable substances after completion of the reaction. No further by-products are formed.

In order to carry out this substitution reaction, the starting materials can be introduced together into the reaction apparatus and heated to the reaction temperature under an inert-gas atmosphere with good mixing. The sequence of addition of the components can be selected as desired. The starting compounds can be pre-dissolved or suspended in a suitable solvent or added as a solid or liquid without a solvent.

Depending on the reactivity of the imidazole of the general formula (III) or (IV) employed, the reaction takes place within a short time or requires a number of days with maintenance of the reaction temperature. The reaction time can be from 15 minutes to 7 days. It is preferably from 30 minutes to 6 days and very preferably from 30 minutes to 5 days.

Suitable solvents which can be used for carrying out the reaction are inert, aprotic solvents.

Suitable inert solvents are, for example, hydrocarbons, such as hexane, petroleum ether, benzene, toluene or xylene; chlorinated hydrocarbons, such as trichloroethylene, 1,2-dichloroethane, tetrachloromethane, chloroform or dichloromethane; alcohols, such as methanol, ethanol, isopropanol, n-propanol, n-butanol or tert-butanol; ethers, such as diethyl ether, diisopropyl ether, tetrahydrofuran (THF) or dioxane; glycol ethers, such as ethylene glycol monoethyl or monomethyl ether, ethylene glycol dimethyl ether (diglyme); ketones, such as acetone or butanone; amides, such as acetamide, dimethylacetamide or dimethylformamide (DMF); nitriles, such as acetonitrile; sulfoxides, such as dimethyl sulfoxide (DMSO); carbon disulfide; carboxylic acid, such as formic acid or acetic acid; nitro compounds, such as nitromethane or nitrobenzene; esters, such as ethyl acetate, water, or mixtures of the said solvents.

Particular preference is given to the use of a solvent selected from the group consisting of hydrocarbons, chlorinated hydrocarbons and ethers.

The reaction is preferably carried out under a protective-gas atmosphere. Nitrogen or argon can be employed for this purpose.

The stoichiometric ratio of the starting materials heterocyclic compound and Hal-R—SiR′ₙ(OR′)₃₋ₙ is between 1:1 and 1:10, preferably between 1:1 and 1:3 and particularly preferably between 1:1 and 1:2.

The reaction can be carried out at a temperature in the range from 20 to +200° C., preferably from 20 to 100° C. and very preferably between 60 and 100° C. The highest yields are obtained at the boiling point of Hal-R—SiR′ₙ—(OR′)₃₋ₙ.

After removal of the volatile constituents in a high vacuum, the crude product is purified by extraction or crystallisation. The compounds of the general formulae (I) and (II) can be isolated in pure form as substances and can subsequently be characterised analytically and spectroscopically.

The compounds of the general formulae (I) and (II) are prepared by reaction of the alkoxysilyl-functionalised imidazolium salts (V) and alkoxysilyl-functionalised 4,5-dihydroimidazolium salts (VI) respectively with a suitable base in anhydrous, inert, aprotic, organic solvents in accordance with reaction equations Eq. 1 and Eq. 2. This reaction can, if desired, be carried out directly after the preparation of the imidazolium salts (V) or 4,5-dihydroimidazolium salts (VI) respectively without prior purification. Bases which are suitable for this reaction are metal alkoxides of the general formula MOR or bases selected from the group consisting of the metal hydrides MH, metal amides MNH₂ and ammonia in an anhydrous, inert, aprotic, organic solvent. Preference is given to the use of NH₃/NaH or a metal hydride or a metal alkoxide as base. KO^{t}Bu) and KH have proven very particularly suitable in various reactions.

The performance of the reaction alkoxysilyl-functionalised imidazolium salts (V) or alkoxysilyl-functionalised 4,5-dihydroimidazolium salts (VI) with a suitable base is not crucial per se. The reaction can be carried out in a simple manner in plants in which all parts and devices which come into contact with the reactants are inert to the chemicals employed and exhibit no corrosion or leaching phenomena. The crucial factors are that the plant can be heated, offers safe feed and discharge of the reactants and reaction products and has means for intensive mixing of the reaction solution. The plant should furthermore enable working under an inert-gas atmosphere and safe discharge of volatile substances. Accordingly, the reaction can also be carried out in a glass apparatus equipped with stirrer, feed and optionally discharge, with reflux condenser or condensation cooler with discharge, if this apparatus also offers the possibility of blanketing with inert gas. However, the reaction can also be carried out in an industrial plant which is manufactured, if appropriate, from stainless steel or other suitable inert materials and has the requisite devices for temperature control, feed and discharge of the starting materials and products.

The reaction is usually carried out in batch mode, in particular if the reaction takes place slowly.

If relatively large amounts of the desired products of the general formulae (I) or (II) are to be prepared and if the starting materials to be reacted are reactive compounds of the general formulae (V) and (VI), it may be appropriate to carry out the reactions in a corresponding plant which is designed for continuous operation.

In order to carry out the reaction, all reactants can be employed together in the reaction vessel. The sequence of addition of the components can be selected as desired.

The starting compounds can be pre-dissolved or suspended in a suitable solvent selected from the above-mentioned inert solvents. The solvents used are preferably ethers, particularly preferably cyclic ethers, such as, for example, tetrahydrofuran.

The protective-gas atmosphere used can be nitrogen or argon. It is preferred to work under a nitrogen atmosphere.

The stoichiometric ratio of the starting materials imidazolium salt [(V) or (VI)] and the base employed is between 1:1 and 1:10, preferably between 1:1 and 1:3 and particularly preferably between 1:1 and 1:1.2.

The reaction can be carried out at a temperature in the range from −78° C. to +100° C., preferably from −40° C. to +60° C. and very preferably between 0° C. and 30° C.

The reaction time is from 1 minute to 6 hours, preferably from 5 minutes to 2 hours and very preferably from 10 minutes to 1 hour.

After any solid by-products that have formed have been removed by filtration and the volatile constituents have been removed in a high vacuum, the product (I) or (II) formed by the reaction with the base can be separated off by extraction with a nonpolar aprotic solvent. The compounds of the general formulae (I) and (II) can optionally be isolated in pure form as solids by crystallisation in a simple manner without further effort and can be characterised spectroscopically.

The compounds of the general formulae (I) and (II) can be used as complex ligands for the preparation of immobilisable N-heterocyclic carbene complexes containing main-group metal atoms, rare-earth metal atoms and transition-metal atoms. In addition, the compounds of the general formulae (I) and (II) can be employed as ligands in catalysts in catalytic reactions, preferably in C—C coupling reactions, oligomerisations, hydrogenations, hydroformylations, aminations, oxidations and reductions. They can furthermore be used as starting material for the preparation of immobilised N-heterocyclic carbenes.

### 4. EXAMPLES

For better understanding and in order to illustrate the invention, examples are given below which fall within the scope of protection of the present invention. However, owing to the general validity of the inventive principle described, these are not suitable for reducing the scope of protection of the present application merely to these examples.

### Example 1

### Synthesis of 1-[3-(triethoxysilyl)propyl]-3-(mesityl)imidazol-2-ylidene

15 ml of tetrahydrofuran, 2.3 mmol of 1-[3-(triethoxysilyl)propyl]-3-(mesityl)-imidazolium chloride and 2.4 mmol of potassium tertiary-butoxide are introduced under an inert-gas atmosphere into a flask and stirred at 25° C. for 30 minutes. The volatile constituents are removed under reduced pressure. 20 ml of heptane are added to the residue, and the precipitated solid (potassium chloride) is removed by filtration. The heptane is removed completely under reduced pressure. The product is obtained as an oil.

¹H-NMR (C₆D₆): δ 0.62-0.72 (m, 2H, SiCH₂), 1.15 (t, ³J=7 Hz, 9H, CH₂CH₃), 2.06 (s, 6H, o-C₆H₂Me₂), 2.13 (s, 3H, p-C₆H₂Me), 3.77 (q, ³J=7.0 Hz, 6H, OCH₂), 4.04 (t, ³J=7 Hz, 2H, NCH₂), 6.42-6.44 (m, 1H, NCHCHN), 6.62-6.65 (m, 1H, NCHCHN), 6.76 (s, 2H, C₆H₂Me₃). The signal of the NCH₂CH₂ protons is covered by the signal of the methyl protons of the mesityl radical.

### Example 2

### Synthesis of 1-[4-(trimethoxysilyl)benzyl]-3-(mesityl)imidazol-2-ylidene

5 ml of tetrahydrofuran, 1.26 mmol of 1-[4-(trimethoxysilyl)benzyl]-3-(mesityl)imidazolium chloride and 1.25 mmol of potassium t-butoxide are introduced under an inert-gas atmosphere into a flask and stirred at 25° C. for 30 minutes. The volatile constituents are removed under reduced pressure. 20 ml of heptane are added to the residue, and the precipitated solid (potassium chloride) is removed by filtration. The heptane is removed completely under reduced pressure. The product is obtained as an oil.

¹H-NMR (C₆D₆): δ 2.10 (s, 6H, o-C₆H₂Me₂), 2.14 (s, 3H, p-C₆H₂Me), 3.48 (s, 9H, OCH₃), 5.20 (s, 2H, NCH₂), 6.35 (s, 1H, NCH), 6.52 (s, 1H, NCH), 6.77 (s, 2H, C₆H₂Me₃), 7.27 (d, ³J=8 Hz, 2H, C₆H₄), 7.82 (d, ³J=8 Hz, 2H, C₆H₄).

¹³C-NMR (C₆D₆): δ 18.7, 21.6 (CH₂CH₃, p-C₆H₂Me, o-C₆H₂Me₂), 51.2 (OCH₃), 55.5 (NCH₂), 119.7, 122.0 (NCHCHN), 129.8 (aryl C_{3,5}), 127.9 (C₆H₄), 136.2 (C₆H₄), 215.1 (NCN). It was not possible to assign the quaternary carbon atoms unambiguously owing to commencing decomposition reactions.

1. Compounds of the general formulae (I) and (II) 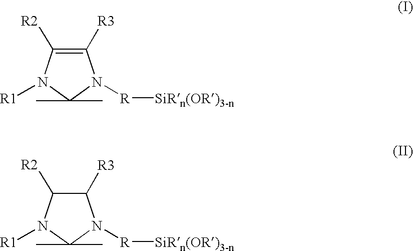
in which
R is A, Ar, A-Ar, A-Ar-A, Het, AHet or AHetA having a total of not more than 30 carbon atoms, where
A is a straight-chain, branched, saturated or mono- or polyunsaturated C₁-C₂₀-alkyl radical, cycloalkyl or cycloalkyl bonded via one or two alkyl group(s) having a total of 4-30 carbon atoms, where one CH₂ or CH group both in the alkyl radical and in the cycloalkyl radical may be replaced by N, NH, NA, O and/or S,
Ar is mono- or polysubstituted or unsubstituted phenyl, naphthyl, anthryl or phenanthryl having a total of not more than 20 carbon atoms, where substituents may be A, Hal, OA, CO-AOH, COOH, COOA, COA, OH, CN, CONHA, NO₂, ═NH or ═O,
Het is a monocyclic or bicyclic, saturated, unsaturated or aromatic heterocyclic radical having from 1 to 4 N, O and/or S atoms, which may be unsubstituted or mono-, di- or trisubstituted by Hal and/or A, OA, CO-AOH, COOH, COOA, COA, OH, CN, CONHA, NO₂, ═NH or ═O,
R′, independently of the position in the molecule, is A, Ar, A-Ar or A-Ar-A having 1-12 carbon atoms,
R1 is A, Ar, AAr, AArA, Het, AHet or AHetA having 1-18 carbon atoms, in which the radical A which is not bonded to Ar or Het is alkyl or cycloalkyl which is unsubstituted or substituted by one or more groups Z, and Ar is an aromatic hydrocarbon which is unsubstituted or mono- or polysubstituted by a group Z, and Het is a saturated, unsaturated or aromatic heterocyclic radical, which may be mono- or polysubstituted by a group Z, and
R2 and R3, independently of one another, are H, Z, Hal or A, Ar or AAr having 1-18 carbon atoms, in which the radical A which is not bonded to Ar or Het is alkyl or cycloalkyl which is unsubstituted or substituted by one or more groups Z, and Ar is an aromatic hydrocarbon which is unsubstituted or mono- or polysubstituted by a group Z,
where
Hal is F, Cl, Br or I,
Z, independently of the position in R1, R2 and R3, is an N, P, O or S atom-containing functional group, A or Ar, and
n is 0, 1 or 2.

2. Compounds according to claim 1 of the general formulae (I) and (II),
in which
R is A, Ar, A-Ar, A-Ar-A, Het, AHet or AHetA having a total of not more than 20 carbon atoms,
R′, independently of the position in the molecule, is a straight-chain, branched, saturated, mono- or polyunsaturated C₁-C₇-alkyl radical, R1 is A, Ar, AAr, AArA, Het, AHet or AHetA having 1-18 carbon atoms, in which the radical A which is not bonded to Ar or Het is alkyl or cycloalkyl which is unsubstituted or substituted by one or more groups Z, and Ar is an aromatic hydrocarbon which is unsubstituted or mono- or polysubstituted by a group Z, and Het is a saturated, unsaturated or aromatic heterocyclic radical, which may be mono- or polysubstituted by a group Z, and
R2 and R3, independently of one another, are H, Cl, Br or a straight-chain, branched, saturated, mono- or polyunsaturated C₁-C₇-alkyl radical,
Z is A,
and
n is O,
and A, Ar and Het are as defined in claim 1.

3. Compounds according to claim 1 of the general formulae (I) and (II),
in which
R is A, Ar, A-Ar or A-Ar-A having a total of not more than 20 carbon atoms, where
A is a straight-chain or branched, saturated C₁-C₁₂-alkyl radical, cycloalkyl having 3-10 carbon atoms or C₄-C₂₀-cycloalkyl bonded via one or two alkyl group(s),
Ar is phenyl which is mono- or polysubstituted or unsubstituted, where substituents can adopt the meanings of A, and R has a total of not more than 20 carbon atoms,
R′, independently of the position in the molecule, is a straight-chain, branched, saturated C₁-C₇-alkyl radical,
R1 is A having the meaning of cycloalkyl which is unsubstituted or substituted by one or more groups Z,
or
Ar an aromatic hydrocarbon which is unsubstituted or substituted by Z=A,
R2 and R3, independently of one another, are H or a straight-chain, branched, saturated C₁-C₇-alkyl radical,
Z is A,
and
n is 0,
and A and Ar are as defined in claim 1.

4. Compounds according to claim 1 of the general formulae (I) and (II),
in which
R′, independently of the position in the molecule, is methyl, ethyl, propyl, isopropyl, butyl, isobutyl, sec- or tert-butyl, pentyl, 1-, 2- or 3-methylbutyl (—C₅H₁₀—), 1,1-, 1,2- or 2,2-dimethylpropyl (—C₅H₁₂—), 1-ethylpropyl (—C₅H₁₀—), hexyl (C₆H₁₂—), 1-, 2-, 3- or 4-methylpentyl (—C₆H₁₂—), 1,1-, 1,2-, 1,3-, 2,2-, 2,3- or 3,3-dimethylbutyl (—C₆H₁₂—), 1- or 2-ethylbutyl (—C₆H₁₂—), 1-ethyl-1-methylpropyl (—C₆H₁₂—), 1-ethyl-2-methylpropyl (—C₆H₁₂—), 1,1,2- or 1,2,2-trimethylpropyl (—C₆H₁₂—), heptyl or octyl.

5. Compounds according to claim 1 of the general formulae (I) and (II), in which
R is A, Ar or A-Ar,
where
A is a straight-chain, saturated C₁-C₁₂-alkyl radical or C₃-C₉-cycloalkyl, or
Ar is phenyl, unsubstituted or mono- or polysubstituted by Z=A,
R′, independently of the position in the molecule, is a straight-chain or branched, saturated C₁-C₄-alkyl radical,
R1 is A having the meaning of cycloalkyl, or
Ar is an aromatic hydrocarbon which is unsubstituted or mono- or polysubstituted by Z=A,
R2 and R3 are H,
and
n is 0,
and A and Ar are as defined in claim 1.

6. Compounds according to claim 1 of the general formulae (I) and (II), in which
R is methyl, ethyl, propyl, isopropyl, butyl, isobutyl, sec- or tert-butyl, 1,2-cyclopropyl, 1,2- or 1,3-cyclobutyl, 1,2- or 1,3-cyclopentyl, 1,2-, 1,3- or 1,4-cyclohexyl, furthermore 1,2-, 1,3- or 1,4-cycloheptyl, methylcyclopentyl, methylcyclohexyl, phenyl, benzyl (CH₂C₆H₄—), tolyl (—C₆H₃(CH₃)—), —C₆H₂(CH₃)₂—, —CH₂C₆H₂(CH₃)₂—, —CH₂C₆H₄CH₂—, —CH₂C₆H₂(CH₃)₂CH₂—, trimethylphenyl or naphthyl,
R′ is methyl, ethyl, propyl, isopropyl, butyl, isobutyl, sec- or tert-butyl,
R3 is cyclopropyl, cyclobutyl, cyclopentyl, cyclohexyl, methylcyclopentyl, cycloheptyl, methylcyclohexyl, cyclooctyl, furanyl, phenyl, benzyl, tolyl, trimethylphenyl, 2,4,6-methylphenyl (mesityl), triisopropylphenyl or naphthyl,
R1, R2 and R4 are H, methyl or ethyl,
n is 0.

7. 1-[3-(triethoxysilyl)ethyl]-3-[2,4-(di-i-propyl)phenyl]imidazol-2-ylidene 1-[3-(trimethoxysilyl)ethyl]-3-[2,4-(di-i-propyl)phenyl]imidazol-2-yl-idene 1-[3-(triethoxysilyl)propyl]-3-[2,4-(di-i-propyl)phenyl]imidazol-2-yl-idene 1-[3-(trimethoxysilyl)propyl]-3-[2,4-(di-i-propyl)phenyl]imidazol-2-yl-idene 1-[3-(triethoxysilyl)butyl]-3-[2,4-(di-i-propyl)phenyl]imidazol-2-ylidene 1-[3-(trimethoxysilyl)butyl]-3-[2,4-(di-i-propyl)phenyl]imidazol-2-ylidene 1-[3-(triethoxysilyl)ethyl]-3-(mesityl)imidazol-2-ylidene 1-[3-(trimethoxysilyl)ethyl]-3-(mesityl)imidazol-2-ylidene 1-[3-(triethoxysilyl)propyl]-3-(mesityl)imidazol-2-ylidene 1-[3-(trimethoxysilyl)propyl]-3-(mesityl)imidazol-2-ylidene 1-[3-(triethoxysilyl)butyl]-3-(mesityl)imidazol-2-ylidene 1-[3-(trimethoxysilyl)butyl]-3-(mesityl)imidazol-2-ylidene 1-[3-(triethoxysilyl)ethyl]-3-(phenyl)imidazol-2-ylidene 1-[3-(trimethoxysilyl)ethyl]-3-(phenyl)imidazol-2-ylidene 1-[3-(triethoxysilyl)propyl]-3-(phenyl)imidazol-2-ylidene 1-[3-(trimethoxysilyl)propyl]-3-(phenyl)imidazol-2-ylidene 1-[3-(triethoxysilyl)butyl]-3-(phenyl)imidazol-2-ylidene 1-[3-(trimethoxysilyl)butyl]-3-(phenyl)imidazol-2-ylidene 1-[3-(triethoxysilyl)ethyl]-3-(cyclohexyl)imidazol-2-ylidene 1-[3-(trimethoxysilyl)ethyl]-3-(cyclohexyl)imidazol-2-ylidene 1-[3-(triethoxysilyl)propyl]-3-(cyclohexyl)imidazol-2-ylidene 1-[3-(trimethoxysilyl)propyl]-3-(cyclohexyl)imidazol-2-ylidene 1-[3-(triethoxysilyl)butyl]-3-(cyclohexyl)imidazol-2-ylidene 1-[3-(trimethoxysilyl)butyl]-3-(cyclohexyl)imidazol-2-ylidene 1-[3-(triethoxysilyl)ethyl]-3-(t-butyl)imidazol-2-ylidene 1-[3-(trimethoxysilyl)ethyl]-3-(t-butyl)imidazol-2-ylidene 1-[3-(triethoxysilyl)propyl]-3-(t-butyl)imidazol-2-ylidene 1-[3-(trimethoxysilyl)propyl]-3-(t-butyl)imidazol-2-ylidene 1-[3-(triethoxysilyl)butyl]-3-(t-butyl)imidazol-2-ylidene 1-[3-(trimethoxysilyl)butyl]-3-(t-butyl)imidazol-2-ylidene 1-[3-(triethoxysilyl)ethyl]-3-(i-propyl)imidazol-2-ylidene 1-[3-(trimethoxysilyl)ethyl]-3-(i-propyl)imidazol-2-ylidene 1-[3-(triethoxysilyl)propyl]-3-(i-propyl)imidazol-2-ylidene 1-[3-(trimethoxysilyl)propyl]-3-(i-propyl)imidazol-2-ylidene 1-[3-(triethoxysilyl)butyl]-3-(i-propyl)imidazol-2-ylidene 1-[3-(trimethoxysilyl)butyl]-3-(i-propyl)imidazol-2-ylidene 1-[3-(triethoxysilyl)ethyl]-3-(methyl)imidazol-2-ylidene 1-[3-(trimethoxysilyl)ethyl]-3-(methyl)imidazol-2-ylidene 1-[3-(triethoxysilyl)propyl]-3-(methyl)imidazol-2-ylidene 1-[3-(trimethoxysilyl)propyl]-3-(methyl)imidazol-2-ylidene 1-[3-(triethoxysilyl)butyl]-3-(methyl)imidazol-2-ylidene 1-[3-(trimethoxysilyl)butyl]-3-(methyl)imidazol-2-ylidene 1-[4-(trimethoxysilyl)benzyl]-3-(mesityl)imidazol-2-ylidene 1-[4-(triethoxysilyl)benzyl]-3-(mesityl)imidazol-2-ylidene 1-[4-(trimethoxysilyl)benzyl]-3-(cyclohexyl)imidazol-2-ylidene 1-[4-(triethoxysilyl)benzyl]-3-(cyclohexyl)imidazol-2-ylidene 1-[4-(trimethoxysilyl)benzyl]-3-(methyl)imidazol-2-ylidene 1-[4-(triethoxysilyl)benzyl]-3-(methyl)imidazol-2-ylidene 1-[4-(trimethoxysilyl)benzyl]-3-(phenyl)imidazol-2-ylidene 1-[4-(triethoxysilyl)benzyl]-3-(phenyl)imidazol-2-ylidene 1-[4-(trimethoxysilyl)benzyl]-3-(i-propyl)imidazol-2-ylidene 1-[4-(triethoxysilyl)benzyl]-3-(i-propyl)imidazol-2-ylidene 1-[4-(trimethoxysilyl)benzyl]-3-(t-butyl)imidazol-2-ylidene 1-[4-(triethoxysilyl)benzyl]-3-(t-butyl)imidazol-2-ylidene 1-[4-(trimethoxysilyl)benzyl]-3-[2,4-(di-i-propyl)phenyl]imidazol-2-ylidene 1-[4-(triethoxysilyl)benzyl]-3-[2,4-(di-i-propyl)phenyl]imidazol-2-ylidene 1-[4-(trimethoxysilyl)-2,4-(dimethyl)phenyl]-3-(mesityl)imidazol-2-ylidene 1-[4-(triethoxysilyl)-2,4-(dimethyl)phenyl]-3-(mesityl)imidazol-2-ylidene 1-[4-(trimethoxysilyl)-2,4-(dimethyl)phenyl]-3-(cyclohexyl)imidazol-2-ylidene 1-[4-(triethoxysilyl)-2,4-(dimethyl)phenyl]-3-(cyclohexyl)imidazol-2-ylidene as compounds according to claim 1.

8. Process for the preparation of compounds of the general formulae (I) and (II), characterised in that a substituted imidazole of the general formula (III) 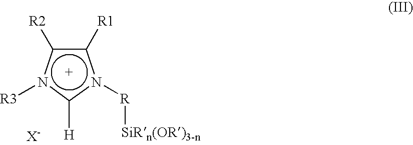
or a substituted 4,5-dihydroimidazole of the general formula (IV) 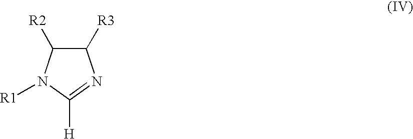
is reacted with a chlorine-, bromine- or iodine-containing alkoxysilane of the general formula
Hal-R—SiR′ₙ(OR′)₃₋ₙ
optionally in an inert, aprotic, organic solvent, to give alkoxysilyl-functionalised imidazolium salts of the general formula (V) 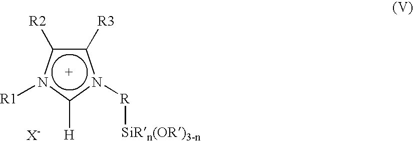
or alkoxysilyl-functionalised 4,5-dihydroimidazolium salts of the general formula (VI) respectively 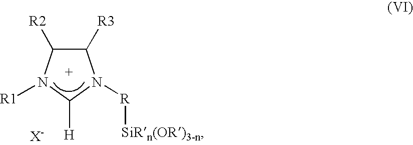
where, in the general formulae, R, R′, R1, R2 and R3 can adopt the meanings of the preceding claims, and X⁻ can be an anion from the group consisting of F⁻, Cl⁻, Br⁻ and I⁻, and the resultant compounds of the general formula (V) or (VI) respectively, either directly in the resultant reaction mixture or after separation and, if necessary, purification, are reacted with a base selected from the group consisting of metal alkoxides (MOR), metal hydrides (MH), metal amides (MNH₂) and/or ammonia in an anhydrous, inert, aprotic, organic solvent which has, if appropriate, already been added in order to carry out the previous reaction, to give the carbenes of the general formulae (I) and (II) respectively.

9. Process according to claim 8, characterised in that, for the isolation and purification of the carbenes of the general formulae (I) and (II), after any solid by-products that have formed have been removed by filtration, the volatile constituents are separated off in a high vacuum, and the crude product is purified by extraction and, if desired, by crystallisation.

10. Process according to claim 8, characterised in that the compounds of the general formulae (V) and (VI) are reacted with a metal alkoxide MOR, metal hydride MH or with NH₃/NaH as base to give a carbene of the general formulae (I) and (II) respectively, where an inert solvent selected from the group consisting of hexane, benzene, toluene and xylene; petroleum ether; ethers, such as diethyl ether, diisopropyl ether, tetrahydrofuran (THF) and dioxane; glycol ethers, such as ethylene glycol dimethyl ether (diglyme); ketones, such as acetone and butanone; esters, such as ethyl acetate, and mixtures of the said solvents, is used.

11. Process according to claim 8, characterised in that the compounds of the general formulae (V) and (VI) are reacted with a metal alkoxide MOR or metal hydride MH as base in a solvent selected from the group consisting of hydrocarbons, such as hexane, benzene, toluene and xylene; petroleum ether, ethers, such as diethyl ether, diisopropyl ether, tetrahydrofuran (THF) and dioxane.

12. Process according to claim 8, characterised in that the compounds of the general formulae (V) and (VI) are reacted with KO^{t}Bu or KH as base to give carbenes of the general formulae (I) and (II) respectively.

13. Process according to claim 8, characterised in that, for the preparation of the carbenes of the general formulae (I) and (II), the starting materials imidazolium salt [(V) or (VI)] and base are employed in a stoichiometric ratio in a range between 1:1 and 1:10, preferably between 1:1 and 1:3 and particularly preferably between 1:1 and 1:1.2, and the reaction is carried out under a protective-gas atmosphere consisting of a gas selected from the group consisting of nitrogen and argon, where the temperature is held in a range from −78° C. to +100° C., preferably from −40° C. to +60° C. and very preferably between 0° C. and 30° C.

14. Process according to claim 8, characterised in that the reaction of the starting materials imidazolium salt [(V) or (VI)] with a base to give carbenes of the general formulae (I) and (II) respectively is carried out within a reaction time of from one minute to 6 hours, preferably from five minutes to 2 hours and very preferably within from 10 minutes to 1 hour.

15. Use of compounds of the general formulae (I) and (II) as starting material for the preparation of immobilised N-heterocyclic carbenes and N-heterocyclic carbene complexes.

16. Use of compounds of the general formulae (I) and (II) as complex ligands for the preparation of immobilisable N-heterocyclic carbene complexes containing main-group metal atoms, rare-earth metal atoms and transition-metal atoms.

17. Use of compounds of the general formulae (I) and (II) as starting material for the preparation of immobilisable catalysts or immobilised N-heterocyclic carbene catalyst ligands.

18. Use of compounds of the general formulae (I) and (II) as components or catalysts in organic or organometallic and transition metal-catalysed reactions.

19. Use of compounds of the general formulae (I) and (II) as catalyst ligands in catalytic reactions, preferably in C—C coupling reactions, oligomerisations, hydrogenations, hydroformylations, aminations, oxidations and reductions.

20. Use of compounds of the general formulae (I) and (II) as reaction media in organic or organometallic and transition metal-catalysed reactions.

21. Use of compounds of the general formulae (I) and (II) as starting materials for immobilised reaction media.

22. Use of compounds of the general formulae (I) and (II) as medium for the purification of reaction products (scavenger function).
